(19) United States
(12) Patent Application Publication
(10) Pub. No.: US 2006/0060673 A1
(43) Pub. Date: Mar. 23, 2006

(54) Injector with separately controllable injector needles

(76) Inventors: Gerhard Mack, Stuttgart (DE); Thomas Kuegler, Korntal-Muenchingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/215,976

(22) Filed: Sep. 1, 2005

Related U.S. Application Data
(63) Continuation of application No. 10/181,771.

(30) Foreign Application Priority Data
Nov. 22, 2000 (DE) 1 00 58 153.6

(51) Int. Cl. F02M 63/00

(52) U.S. Cl. 239/533.2

(57) ABSTRACT

An injection nozzle for internal combustion engines is proposed, having a nozzle needle 7 and a second nozzle needle 27; the first nozzle needle 7 and the second nozzle needle 27 can be triggered independently of one another. The second injection nozzle is opened by lowering the pressure of a hydraulic fluid in a control chamber 37. By this means, the injection quantity per unit of time and the atomization of the fuel in the combustion chamber can be varied over wide ranges, and moreover a shaping of the injection course can be performed.

### CROSS-REFERENCE TO RELATED APPLICATIONS

This application is based on 35 USC 371 application of PCT/DE 01/04338 filed on Nov. 17, 2001; and a continuation of U.S. Ser. No. 10/181,771.

### BACKGROUND OF THE INVENTION

1. Field of the Invention

The invention relates to an injection nozzle for internal combustion engines, having a nozzle body, wherein the nozzle body has at least one first injection port and at least one second injection port, having a first nozzle needle, embodied as a hollow needle and guided in a guide bore of the nozzle body, having a second nozzle needle disposed coaxially to the first nozzle needle, wherein with the first nozzle needle, the injection of fuel through the at least one first injection port is controllable, and with the second nozzle needle the injection of fuel through the at least one second injection port is controllable.

2. Description of the Prior Art

In the above injection nozzle, known from German Patent Disclosure DE 42 14 646 A1, the two nozzle needles are each triggered via a respective high-pressure fuel pump.

### SUMMARY AND OBJECTS OF THE INVENTION

The object of the invention is to furnish an injection nozzle which is more variable with respect to injection course shaping and fuel atomization and which thus makes internal combustion engines possible that are more economical in fuel consumption, have lower emissions, and are quieter. Moreover, the injection nozzle of the invention should be economical to produce and should be usable without major modifications at the cylinder head of the engine. Finally, the injection systems equipped with the injection nozzles of the invention should also be more economical than known systems of the same variability.

This object is attained according to the invention by an injection nozzle for internal combustion engines, having a nozzle body, wherein the nozzle body has at least one first injection port and at least one second injection port, having a first nozzle needle, embodied as a hollow needle and guided in a guide bore of the nozzle body, having a second nozzle needle disposed coaxially to the first nozzle needle, wherein with the first nozzle needle, the injection of fuel through the at least one first injection port is controllable, and with the second nozzle needle the injection of fuel through the at least one second injection port is controllable, and wherein a pressure force in the closing direction of the second nozzle needle can be exerted on the second nozzle needle by a hydraulic fluid from a located in a control chamber.

In the injection nozzle of the invention, the at least one first injection port can be triggered in a simple way independently from the at least one second injection port. This creates the possibility of opening only the at least one first injection port at certain operating points of the engine upon injection, so that the fuel quantity to be injected can be injected into the combustion chamber through a relatively small injection port cross section. As a result,. first, smaller fuel injection quantities can be injected with greater precision, and second, the fuel injected into the combustion chamber through the at least one first injection port at high speed is better distributed, which has a favorable effect on the efficiency, emissions, and noise of the engine.

In an alternative mode of operation, the at least one second injection port can be opened immediately after the opening of the first injection port, or after a freely selectable time lag, so that a large quantity of fuel can be injected into the combustion chamber in the briefest possible time through the first and second injection ports. Because of the time lag between the opening of the first injection ports and the second injection ports, the injection course can be freely shaped over a wide range. This has advantages in terms of efficiency, the noise produced, and the emissions of the engine.

Moreover, for triggering the second nozzle needle, a second high-pressure fuel pump is not needed. Instead, a simple, economical pressure supply suffices, for instance from the oil pump of the engine. Furthermore, the second nozzle needle can be triggered more simply and precisely, since for opening the second nozzle needle, the pressure in the control chamber need merely be lowered.

Because the second nozzle needle is disposed inside the first nozzle needle, the injection nozzle of the invention takes up no more installation space than an injection nozzle of the prior art and accordingly makes do without miniaturized components, which has a favorable effect on both production costs and mass production.

In a variant of the invention, it is provided that a control chamber that can be subjected to a control pressure is present in the nozzle body, and that a second nozzle spring acting on the second nozzle needle and disposed in the control chamber is present, so that the second nozzle needle is pressed into its closing direction by the second nozzle spring, and the closing force, which is composed of the spring force of the second nozzle spring and the pressure force resulting from the control pressure in the control chamber, can be controlled within wide limits and with high chronological resolution by controlling the control pressure.

To make production and installation upon assembly of the injection nozzle of the invention simpler, the nozzle body is in multiple parts and has both an intermediate ring and a nozzle holder body, and/or a guide bush is provided in the guide bore; the guide bush can also serve as a stroke stop for the second nozzle needle. Using a guide bush is advantageous, for among other reasons, especially because the guide bush can be made of more wear-resistant material, and if the guide bush wears, only the guide bush has to be replaced, rather than the entire injector.

In a further embodiment of the invention, the intermediate ring acts as a stroke stop for the first nozzle needle, so that the stroke of the first nozzle needle can be set with great precision.

In another embodiment of the invention, a control piston is guided in the guide bush; the control piston defines the control chamber and transmits the pressure force, resulting from the control pressure in the control chamber, to the second nozzle needle, so that the area of the end face of the control piston can be selected independently of the diameter of the guide bore.

To simplify installation and calibration, it can be provided that the first nozzle spring is braced at least indirectly, for instance via an adjusting shim, via the guide bush or directly on the nozzle body (1). The guide bush can also serve as a stroke stop for the second nozzle needle, so that the stroke of the second nozzle needle is limited.

In a further feature of the invention, a pressure bolt is provided between the first nozzle spring and the first nozzle needle; the pressure bolt transmits the closing force of the first nozzle spring to the first nozzle needle, which makes for a compact, simple design.

If, as provided in a further advantageous feature of the invention, the pressure bolt serves as a stroke stop for the second nozzle needle, then the stroke stop for the second nozzle needle can be adjusted more precisely, since the axial spacing between the second sealing cone and the stroke stop is very short. Moreover, the second nozzle needle is closed simultaneously with the first nozzle needle, thus avoiding undesired after injections of fuel into the combustion chamber through the second injection ports.

It can additionally be provided that the pressure bolt is guided by the nozzle body, and in particular the intermediate ring of the nozzle body, and/or that the pressure bolt at least partly takes on the guidance of the second nozzle needle, thus further improving production, installation and function.

In another exemplary embodiment of the invention, the second nozzle needle is embodied in two parts, thus simplifying production and installation.

In another feature of the invention, the cross section of the at least one first injection port and the cross section of the at least one second injection port are equal in size, so that at all operating points, good atomization of the fuel in the combustion chamber is obtained.

### BRIEF DESCRIPTION OF THE DRAWINGS

Further advantages and advantageous features of the invention can be learned from the description contained herein below, taken in conjunction with the drawings, in which:

FIG. 1, a first exemplary embodiment of an injection nozzle of the invention;

FIG. 2, an enlarged detail of FIG. 1; and

FIG. 3, a second exemplary embodiment of an injection nozzle of the invention.

### DESCRIPTION OF THE PREFERRED EMBODIMENTS

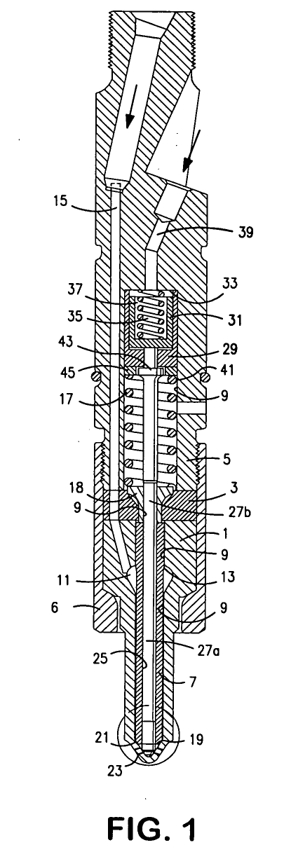

FIG. 1 shows an exemplary embodiment of an injection nozzle of the invention in longitudinal section. The nozzle body 1 is adjoined by a shim 3 and a nozzle holder body 5. The nozzle body 1, shim 3 and nozzle holder body 5 can also be embodied in one piece. The multi-part embodiment shown in FIG. 1, however, has advantages in terms of the production, installation and adjustment of the injection nozzle. The nozzle body 1, shim 3 and nozzle holder body 5 are braced against one another by means of a union nut 6. At the same time, the shim 3 is a stroke stop for the first nozzle needle 7.

In the nozzle body 1, a first nozzle needle 7 is guided in a guide bore 9. The guide bore 9 continues in the shim 3 and nozzle holder body 5 as well and has changing diameters.

In the nozzle body 1, a pressure chamber 11 is embodied, which is defined by a pressure shoulder 13 of the first nozzle needle 7. Via a high-pressure inlet 15, fuel from a high-pressure fuel pump, not shown, can be pumped into the pressure chamber 11.

A first nozzle spring 17, via a pressure bolt 18, presses the first nozzle needle 17 into a first sealing seat 19, shown only in suggested form in FIG. 1, at the end of the nozzle body 1.

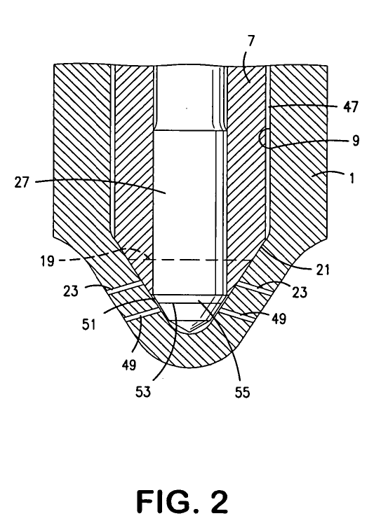

In the closed state of the first nozzle needle 7, a sealing cone 21 of the first nozzle needle 7, in conjunction with the first sealing seat 19, prevents fuel from the pressure chamber 11 from passing through a first injection port 23 into the combustion chamber, not shown in FIG. 1, of an internal combustion engine, also not shown. The tip of the nozzle needle of the invention is shown in more detail in FIG. 2 and will be described in greater detail below in conjunction with that figure.

The mode of operation of the first nozzle needle is equivalent to that of a conventional injection nozzle. If the pressure force exerted on the pressure shoulder 13 by the fuel located in the pressure chamber 11 is greater than the closing force of the first nozzle spring 17, the first nozzle needle 7 lifts from the first sealing seat 19 and thus uncovers the at least one first injection port 23, and the injection begins. Fuel flows out of the pressure chamber 11 through an annular gap (not shown), formed by the guide bore 9 and the first nozzle needle 7, in the direction of the first injection port 23.

The first nozzle needle 7 has a central bore 25, in which a second nozzle needle 27 is guided. The second nozzle needle 27, in the exemplary embodiment shown in FIG. 1, is embodied in two parts and comprises the portions 27a and 27b. The two-part embodiment of the second nozzle needle 27 is done for reasons of production and installation. In the region of the nozzle holder body 5, a guide bush 29 is provided on the upper end of the guide bore 9, and a control piston 31 is guided in the guide bush.

Between the control piston 31 and the end 33 of the guide bore 9, a second nozzle spring 35 is disposed, which causes the control piston 31 to contact the second nozzle needle 27. The end 33 of the guide bore 9 and the control piston 31 define a control chamber 37, into which a control pressure inlet 39 discharges. The control chamber 37 is filled with a hydraulic fluid, whose pressure can be controlled via the control pressure inlet 39. Fuel, motor oil, and other fluids can be used as the hydraulic fluid.

The pressure of the control chamber 37 filled with hydraulic fluid is exerted via the control piston 31, in the same direction as the second nozzle spring 35, on the second nozzle needle 27 and presses this nozzle needle into a second valve seat, not shown in FIG. 1. By lowering the pressure in the control chamber 37; the closing force of the second nozzle needle 27 can be decreased to such an extent that the second nozzle needle 27 opens.

An underside 41 of the guide bush 29, together with a shoulder 43 of the second nozzle needle, forms a stroke stop for the second nozzle needle 27.

In the exemplary embodiment shown in FIG. 1, the first nozzle spring 17 is braced against the nozzle holder body 5 via an adjusting shim 45 and the guide bush 29. By changing the adjusting shim 45, the prestressing of the first nozzle spring 17 can be adjusted in the simplest possible way and with high precision.

In FIG. 2, the tip of an injection nozzle of the invention is shown enlarged. The first sealing cone 21 of the first nozzle needle 7 and its counterpart in the nozzle body 1 are designed such that linear contact results. This line of contact will be called the first sealing seat 19 and is shown as a dashed line in FIG. 2. As FIG. 2 clearly shows, the first sealing seat 19 separates the fuel, which is at high pressure, in an annular gap 47 between the guide bore 9 and the first nozzle needle 7 from the first injection ports 23, when the injection nozzle is closed. In the exemplary embodiment of FIG. 2, two first injection ports 23 are shown, which face one another. However, it is also possible for injection nozzles of the invention to be equipped with a different number of first injection ports 23 or second injection ports 49.

Somewhat farther toward the tip of the nozzle body 1, two second injection ports 49 are shown. The second injection ports 49 are sealed off from a second sealing cone 51 and its counterpart in the nozzle body 1. Once again, a linear area of contact results between the second sealing cone 51 and the nozzle body 1, and this will hereinafter be called the second sealing seat 53.

The mode of operation of the injection nozzle of the invention will now be described, referring back and forth to FIG. 1 and FIG. 2.

When the high-pressure fuel system, not shown, which among other elements has a high-pressure fuel pump, pumps fuel at high pressure via the high-pressure inlet into the pressure chamber 11, the first nozzle needle 7 lifts from the first sealing seat 19, as soon as the pressure force, exerted on the pressure shoulder 13 by the fuel in the pressure chamber 11, is greater than the closing force of the first nozzle spring 17. Once the first nozzle needle 7 has lifted from the first sealing seat 19, the fuel can flow out of the pressure chamber 11 via the annular gap 47 through the first injection ports 23 into the combustion chamber, not shown. At some operating points of the engine, not shown, the injection is optimal if the fuel is injected solely through the first injection ports 23.

If the opening cross sections of the first injection ports 23 are inadequate to inject enough fuel into the combustion chambers within the available time, then the second nozzle needle 27 can be opened in addition. This is accomplished by lowering the pressure in the control chamber 37. Since the second sealing seat 53 has a smaller diameter than the second nozzle needle 27, the fuel that is at high pressure and is flowing out of the annular gap 47 toward the first injection ports 23 exerts a force counter to the closing force on an annular face 55 of the second nozzle needle 27. The annular face 55 is defined by the second sealing seat 53 and the outer diameter of the second nozzle needle 27. As soon as this force is greater than the closing force, the latter comprising the spring force of the second nozzle spring 35 and the pressure force of the hydraulic fluid located in the control chamber 37, the second nozzle needle 27 lifts from the nozzle body 1 as well and thus uncovers the second injection ports 49. In this state, large quantities of fuel can flow within a short time through the first injection ports 23 and second injection ports 49 into the combustion chamber, not shown.

If the pressure in the control chamber 37 is lowered with a time lag after the opening of the first nozzle needle 7, an injection course can be shaped. In a first phase, when only the first nozzle needle 7 is opened, only little fuel flows through the first injection ports 23. Upon the opening of the second nozzle needle, the quantity of fuel injected per unit of time increases sharply.

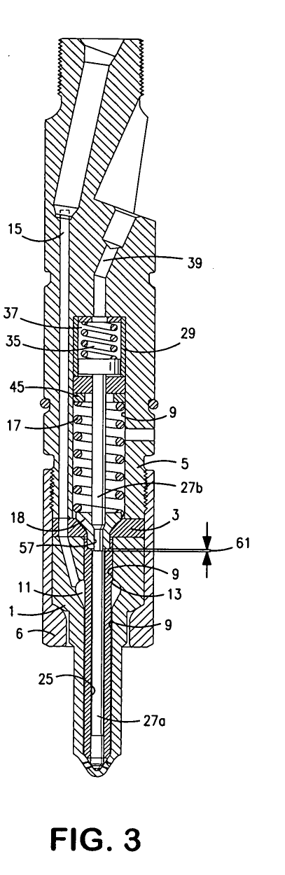

In FIG. 3, a second exemplary embodiment of an injection nozzle of the invention is shown. Because of the agreement with the first exemplary embodiment in terms of components and function, the description of FIGS. 1 and 2 applies, and only the differences will be explained below.

In the exemplary embodiment of FIG. 3, the second nozzle needle 27 is divided at the level of the pressure bolt 18. The upper part 27b of the second nozzle needle 27, where it passes through the pressure bolt 18, has a smaller diameter than the lower part 27a of the second nozzle needle 27. A central bore 57 in the pressure bolt, which bore guides the upper part 27b of the second nozzle needle 27, also has a smaller diameter than the lower part 27a of the second nozzle needle 27. The lower end 59, in terms of FIG. 3, of the pressure bolt 18 therefore forms a stroke stop for the nozzle needle 27. Because of the shorter spacing, compared to the first exemplary embodiment, between the second sealing seat (see FIG. 2) and the stroke stop formed by the lower end 59 of the pressure bolt 18, first, the stroke of the nozzle needle can be adjusted more precisely, and second, it is assured that the stroke of the second nozzle needle 27 is dependent on the stroke of the first nozzle needle 7. The stroke of the second nozzle needle 27 can be greater, at maximum by the stroke play designated as 61 in FIG. 3, than the stroke of the first nozzle needle 7.

When the first nozzle needle 7 closes, the pressure bolt 18, offset by the stroke play 61, also closes the second nozzle needle 27. This prevents after injections into the combustion chamber (not shown) from the second injection ports 49 (see FIG. 2).

It has proved advantageous if the total of the opening cross sections of the first injection ports 23 is approximately equal to the total of the opening cross sections of the second injection ports 49.

The foregoing relates to preferred exemplary embodiments of the invention, it being understood that other variants and embodiments are possible within the spirit and scope of the invention, the latter being defined by the appended claims.

1-17. (canceled)

18. In injection nozzle for internal combustion engines, comprising
a nozzle body (1) having at least one first injection port (23), at least one second injection port (49) and a guide bore formed therein,
a first nozzle needle (7) embodied as a hollow needle and guided in the guide bore (9) of the nozzle body (1),
a second nozzle needle (27) disposed coaxially within the first nozzle needle (7), whereby with the first nozzle needle (7), the injection of fuel through the at least one first injection port (23) is controllable and with the second nozzle needle (27) the injection of fuel through the at least one second injection port (49) is controllable, and
a control chamber (37) for applying a pressure force to the second nozzle needle (27) in the closing direction by a hydraulic fluid from the control chamber (37).

19. The injection nozzle of claim 18, wherein the nozzle body (1) comprises a pressure chamber (11), one end of which is defined by a pressure shoulder (13) of the first nozzle needle (7); the first nozzle needle (7) comprises a first sealing cone (21) cooperating with a first sealing seat (19) of the nozzle body (1); that the second nozzle needle (27) comprises a second sealing cone (51) cooperating with a second sealing seat (53) of the nozzle body (1); and further comprising a first nozzle spring (17), braced on one end against the nozzle body (1) and on the other end against the first nozzle needle (7).

20. The injection nozzle of claim 18, wherein the control chamber (37) is disposed in the nozzle body (1); and further comprising a second nozzle spring (35) acting on the second nozzle needle (27).

21. The injection nozzle of claim 19, wherein the control chamber (37) is disposed in the nozzle body (1); and further comprising a second nozzle spring (35) acting on the second nozzle needle (27).

22. The injection nozzle of claim 18, wherein the nozzle body (1) is embodied in multiple parts and has both an intermediate ring (3) and a nozzle holder body (5).

23. The injection nozzle of claim 22, wherein the intermediate ring (3) acts as a stroke stop for the first nozzle needle (7).

24. The injection nozzle of claim 18, further comprising a control piston (31) guided in the guide bore (9), the control piston (31) defining the control chamber (37) and transmitting the pressure force, resulting from the control pressure in the control chamber (37), to the second nozzle needle (27).

25. The injection nozzle of claim 18, further comprising a guide bush (29) in the guide bore (9), the control piston (31) being guided in the guide bush (29).

26. The injection nozzle of claim 24, wherein the first nozzle spring (17) is braced directly on the nozzle holder body (5).

27. The injection nozzle of claim 25, wherein the first nozzle spring (17) is braced at least indirectly via the guide bush (29).

28. The injection nozzle of claim 24, wherein the first nozzle spring (17) is braced via an adjusting shim (45) on the nozzle holder body (5).

29. The injection nozzle of claim 25, wherein the first nozzle spring (17) is braced via an adjusting shim (45) on the guide bush (29).

30. The injection nozzle of claim 18, further comprising a stroke stop for the second nozzle needle (27) in the guide bore (9).

31. The injection nozzle of claim 25, wherein the guide bush (29) acts as a stroke stop for the second nozzle needle (27).

32. The injection nozzle of claim 19, further comprising a pressure bolt (18) between the first nozzle spring (17) and the first nozzle needle (7), the pressure bolt (18) transmitting the closing force of the first nozzle spring (17) to the first nozzle needle (7).

33. The injection nozzle of claim 32, wherein the pressure bolt (18) acts as a stroke stop for the second nozzle needle (27).

34. The injection nozzle of claim 32, wherein the pressure bolt (18) is guided by an intermediate ring (3) of the nozzle body (1).

35. The injection nozzle of claim 32, wherein the pressure bolt (18) at least partly guides the second nozzle needle (27).

36. The injection nozzle of claim 18, wherein the second nozzle needle (27) is embodied in two parts (27a, 27b).

37. The injection nozzle of claim 18, wherein the cross sections of the first injection port or ports (23) and the cross sections of the second injection port or ports (49) are equal in size.
